(19) United States
(12) Patent Application Publication
(10) Pub. No.: US 2026/0322312 A1
(43) Pub. Date: Oct. 15, 2026

(54) METHOD AND SYSTEM FOR REPLACING A PHOTOVOLTAIC SYSTEM

(71) Applicant: Huzhou Leapting Technology Co., LTD, Huzhou, Zhejiang (CN)

(72) Inventors: Xin SUN, Huzhou, Zhejiang (CN); Tao YU, Huzhou, Zhejiang (CN); Liangliang BAI, Huzhou,Zhejiang (CN)

(73) Assignee: Huzhou Leapting Technology Co., LTD, Huzhou, Zhejiang (CN)

(21) Appl. No.: 19/147,774

(22) PCT Filed: Jul. 31, 2023
(86) PCT No.: PCT/CN2023/110113

§ 371 Date: Jul. 14, 2025

(30) Foreign Application Priority Data
Nov. 17, 2022 (CN) 202211458941.0

(51) Int. Cl. H02S 20/20; B25J 9/16; B25J 13/00; H02S 99/00

(52) U.S. Cl. CPC H02S 20/20; B25J 9/161; B25J 9/1697; B25J 13/006; H02S 99/00

(57) ABSTRACT

A photovoltaic system substitutive method and system. The method comprises the step of: establishing remote interaction between a control center and at least one robot; by means of the control center, controlling the robot to move to the position where a target photovoltaic system is located; and the robot disassembling the target photovoltaic system according to a preset disassembly procedure, and the robot installing the substitutive photovoltaic system according to a preset installation procedure, wherein the disassembly procedure is reversely deduced from a preloaded installation procedure.

### FIELD OF THE DISCLOSURE

The present invention relates to the technical field of photovoltaic power station, and in particular to a substitutive method and system for replacing a photovoltaic system.

### BACKGROUND

Photovoltaic systems are generally distributed in remote regions. If a system is damaged or fails, it is necessary to be replaced on site, otherwise power generation will be significantly affected. Presently, the substitutive of systems mainly relies on manpower. The installation may be achieved via mounting holes or pressure blocks. No matter which method is adopted, manpower is required to disassemble and then move a substitutive system to the designated location for alignment, installation, locking and other steps. These operations require at least two labors to carry out, which is very inefficient and inconvenient. Therefore, a labor-saving and efficient method for replacing photovoltaic systems is needed.

### SUMMARY OF THE INVENTION

The purpose of the present invention is to provide a method and system for replacing a photovoltaic system to solve the problem in the prior art that photovoltaic system substitutive requires a lot of manpower and is inefficient.

The technical solution provided by the present invention is as follows:

The present invention provides a substitutive method for replacing a photovoltaic system, comprising steps:
establishing a remote interaction between a control center and at least one robot;
controlling the robot to go to a location of a target photovoltaic system via the control center;
disassembling the target photovoltaic system according to a preset disassembly procedure by the robot, and installing a substitutive photovoltaic system according to a preset installation procedure, wherein the disassembly procedure is reversely deduced from the preloaded installation procedure.

The disassembly and installation of photovoltaic systems by remotely controlling robots via the control center achieves automatic substitutive of photovoltaic systems and reduces manual operations, facilitates improvement of efficiency and reduction of personal injury risks. It is suitable for substitutive of photovoltaic systems in remote regions.

In some embodiments, before said disassembling the target photovoltaic system according to a preset disassembly procedure by the robot, the method further comprises:
pre-shooting an image of installation components for each installation step during an installation process of a photovoltaic system, and obtaining an installation sequence of the installation components;
obtaining installation parameters of the installation components;
combining the installation parameters of the installation components, obtaining the installation procedure of the photovoltaic system, and loading the installation procedure into the robot, according to the images of installation components and the installation sequence of the installation components.

Before implementation, it is necessary to determine the installation procedures for each installation component in the photovoltaic system. Specifically, before the initial installation, the installation component images corresponding to installation steps during the photovoltaic system installation process are photographed to obtain the installation sequence and installation parameters of each installation component, and the installation procedure of the photovoltaic system can be determined based on the installation component images and the installation sequence of each installation component, combined with the installation parameters of each installation component. After determining the substitutive photovoltaic system, the installation procedure can be directly called or selected.

In some embodiments, said pre-shooting an image of installation components for each installation step during an installation process of a photovoltaic system, specifically comprises:
classifying the installation components according to functional categories, and obtaining an overall installation sequence of the installation components of each functional category and the corresponding images of installation components;
obtaining an individual installation sequence and a corresponding individual installation image of each installation component.

When installing a photovoltaic system, each major installation step can be divided into several sub-steps. During specific operations, the various installation components of the photovoltaic system can be classified according to functional categories. First, the overall installation sequence of the installation components of each functional category and the corresponding installation component images are obtained, and then the individual installation sequence of each installation component and the corresponding individual installation image are obtained, so that a complete installation procedure can be obtained.

In some embodiments, said the disassembly procedure is reversely deduced from the preloaded installation procedure, specifically comprises:
obtaining the disassembly procedure by reversing the installation sequence of the installation components in the installation procedure, and the individual installation sequence of each installation component one by one.

After obtaining the installation procedures for each installation component of the photovoltaic system, corresponding to each installation component of the photovoltaic system, the disassembly procedure can be obtained by reversing the installation sequence of installation components in the installation procedure one by one, and reversing the individual installation sequence of each installation component one by one.

In some embodiments, after establishing remote interaction between the control center and at least one robot, the method further comprises:
controlling the robot to grab a substitutive component corresponding to an installation component to be replaced in the target photovoltaic system, and go to the location of the target photovoltaic system;
controlling the robot to disassemble the installation component to be replaced in the target photovoltaic system according to the disassembly procedure, and install the substitutive component according to the installation procedure;
controlling the robot to grab a disassembled installation component and go to a preset placement location for placing the disassembled installation component.

In some embodiments, the number of the robot is two; and
the control center controls the two robots to move synchronously, and to disassemble the target photovoltaic system and install the substitutive photovoltaic system respectively from two sides.

In another aspect, the present invention also provides a photovoltaic system substitutive system, comprising:
a control center; and
at least one robot, which establishes remote interaction with the control center; wherein the control center controls the robot to go to a location of a target photovoltaic system; and
at least one robot disassembles the target photovoltaic system according to a preset disassembly procedure, and installs a substitutive photovoltaic system according to a preset installation procedure, wherein the disassembly procedure is reversely deduced from the preloaded installation procedure.

The disassembly and installation of photovoltaic systems by remotely controlling the robot via a control center achieves automatic replacement of photovoltaic systems and reduces manual operations, which facilitates improvement of efficiency and reduction of labor injury risks. It is suitable for replacement of photovoltaic systems in remote regions.

In some embodiments, two robots are provided, and each robot comprises a mobile chassis and a mechanical arm 360°-rotatably connected to the mobile chassis, and the mechanical arm is movably connected with a mechanical manipulator; and
the control center controls two robots to move synchronously, and controls the mechanical arms and the mechanical manipulators to disassemble the target photovoltaic system and install the substitutive photovoltaic system respectively from two sides.

In some embodiments, the system further comprises:
a camera module, installed on the mechanical arm or the mechanical manipulator and used to obtain photovoltaic system images in real time.

In some embodiments, the mobile chassis comprises:
a communication module, used to exchange information with the control center and receive control instructions from the control center; and
a positioning module, used to obtain a current position of the robot, and to obtain current positions of the target photovoltaic system and the substitutive photovoltaic system.

The photovoltaic system substitutive method and system provided by the present invention can realize automatic replacement of photovoltaic systems, reduce manual operations, improve efficiency, reduce the risk of labor injury, and is suitable for photovoltaic system replacement in remote regions.

### BRIEF DESCRIPTION OF THE DRAWINGS

The preferred embodiments will be described below in a clear and understandable manner with reference to the accompanying drawings to further illustrate the above-mentioned characteristics, technical features, advantages and implementation methods of the present solution.

FIG. 1 is a schematic diagram of an overall flow chart of an embodiment of the present invention;

FIG. 2 is a schematic diagram of the installation process of a fixed bracket photovoltaic system according to an embodiment of the present invention;

FIG. 3 is a schematic diagram of a detailed installation process of a tracking photovoltaic system according to an embodiment of the present invention;

FIG. 4 is a schematic diagram of a system architecture of an embodiment of the present invention;

FIG. 5 is a functional schematic diagram of a control center according to an embodiment of the present invention;

FIG. 6 is a schematic diagram of the system structure of an embodiment of the present invention.

### DESCRIPTION OF THE ILLUSTRATED EMBODIMENTS

In order to more clearly illustrate the embodiments of the present invention or the technical solutions in the prior art, the specific implementation methods of the present invention will be described below with reference to the accompanying drawings. Obviously, the accompanying drawings described below are only some embodiments of the present invention. For ordinary technicians in this field, other drawings and other implementation methods can be obtained based on these drawings without creative work.

In order to simplify the drawings, only the parts related to the present invention are schematically shown in each figure, and they do not represent the actual structure of products. In addition, in order to simplify the drawings and facilitate understanding, in some figures, only one of the parts with the same structure or function is schematically drawn or marked. In this article, “one” not only means “only one”, but also means “more than one”.

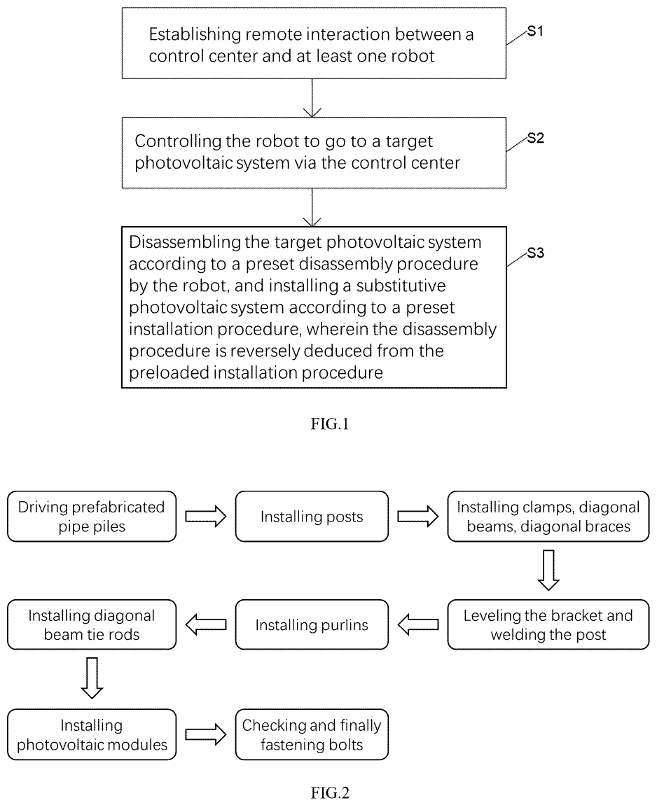

In one embodiment, referring to FIG. 1 of the accompanying drawings of the specification, the present invention provides a photovoltaic system substitutive method, comprising steps:
S1. Establishing remote interaction between a control center and at least one robot.

Each robot comprises a mobile chassis and a mechanical arm rotatably connected to the mobile chassis which allows a 360°movement. Each mechanical arm is movably connected with a mechanical manipulator, to enable operations of grasping, disassembly and installation on various installation components of a photovoltaic system.

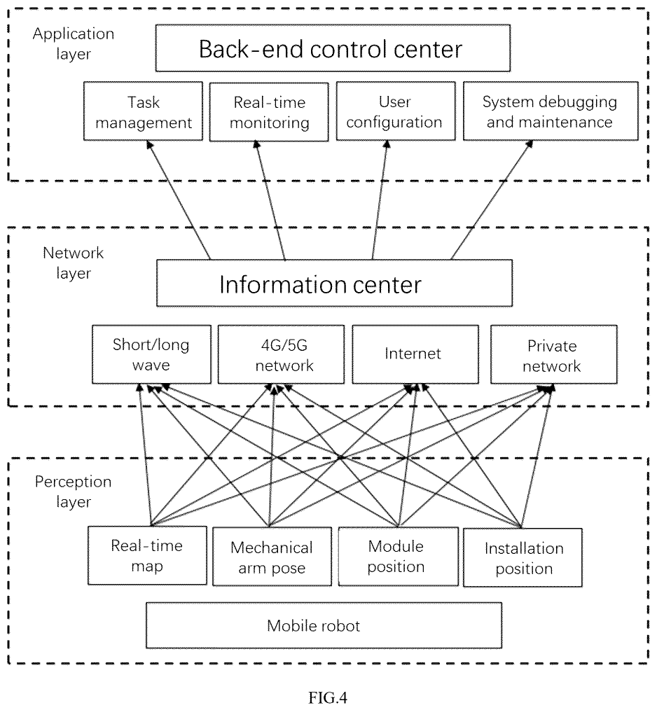

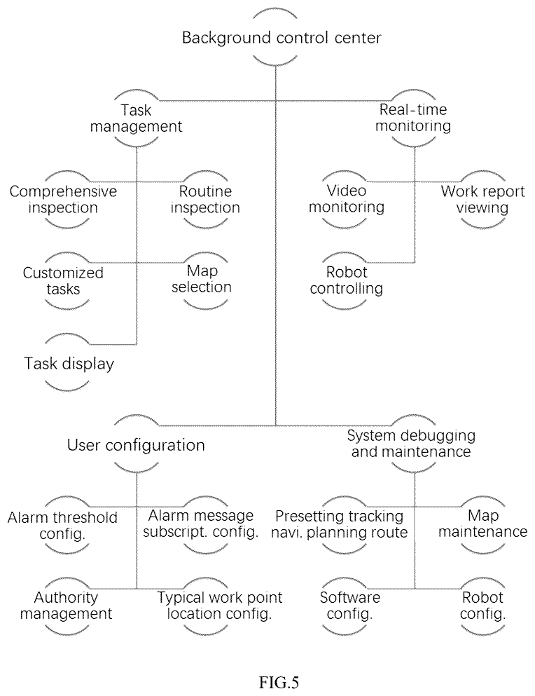

Referring to FIG. 4 and FIG. 5 of the specification, the back-end control center can remotely interact with the robot or robots via 4G, 5G or other signal transmission methods. While achieving remote control, it can also monitor the on-site situation in back end via visual cameras. The function modules of the back-end control center mainly include a task management module, a real-time monitoring module, a user configuration module, a system debugging and maintenance module, etc. Among them, the task management module mainly realizes functions of comprehensive inspections, routine inspections, customized tasks, map selection and task display of the photovoltaic site. The real-time monitoring module mainly realizes functions of video monitoring, work report viewing and robot controlling. The user configuration module mainly realizes functions of alarm threshold configuration, alarm message subscription configuration, authority management, typical work point location configuration, and work area configuration. The system debugging and maintenance module mainly realizes functions of presetting tracking navigation planning route, map maintenance, software configuration and robot configuration.

The robot is equipped with a communication module, which can exchange information with the control center and receive control instructions from the control center. The robot is also equipped with a laser radar, an ultrasonic radar, a visual camera, etc., which can locate the robot, locate a photovoltaic system, and obtain images of a photovoltaic system.
S2. Controlling the robot or robots to the location of a target photovoltaic system via the control center.

When a photovoltaic system needs to be replaced, the control center first obtains the location coordinates of the target photovoltaic system, and then controls the robot to go to the target photovoltaic system automatically for subsequent system substitutive operations.
S3. The robot disassembles the target photovoltaic system according to a preset disassembly procedure, and installs a substitutive photovoltaic system according to a preset installation procedure. The disassembly procedure is reversely deduced from the preloaded installation procedure.

When replacing a photovoltaic system, the photovoltaic system installation procedure is first loaded, and the disassembly procedure is reversely deduced based on the installation procedure. When replacing the photovoltaic system, the robot disassembles the target photovoltaic system according to the derived disassembly procedure, and then installs the substitutive photovoltaic system according to the preset installation procedure, thereby achieving system replacement. Each photovoltaic system corresponds to a set of installation procedures. Before replacing, the type of the substitutive system needs to be determined, and then the corresponding installation procedure are loaded or selected.

This solution uses a control center to remotely control a robot or robots to disassemble and install photovoltaic systems, which can achieve automatic replacement of photovoltaic systems and reduce manual operations, which is conducive to improving efficiency and reducing the risk of labor injury. It is suitable for photovoltaic system replacement in remote regions.

In one embodiment, before the robot disassembles the target system according to a preset disassembly procedure, the process further comprises:
Pre-shooting an image of installation components for each installation step during the photovoltaic system installation process, and obtaining the installation sequence of each the installation components;
Obtaining installation parameters of each installation component;
Obtaining the installation procedure of the photovoltaic system and loading the installation procedure to the robot, according to the images of each installation component and the installation sequence of each installation component, combined with the installation parameters of each installation component.

Before implementing this solution, it is necessary to determine the installation procedure of the installation components in the photovoltaic system. Specifically, before the initial installation, images of installation components corresponding to installation steps in the photovoltaic system installation process are photographed, and the installation sequence and installation parameters (such as the torque value of a certain installation component such as a tightening nut, etc.) of the installation components are obtained, and the installation procedure of the photovoltaic system can be determined based on the images of the installation components and the installation sequence of the installation components, combined with the installation parameters of the installation components. After determining the type of the substitutive photovoltaic system, the installation procedure can be directly called or selected.

Referring to FIG. 2 of the specification, the installation steps of a photovoltaic system such as a fixed bracket photovoltaic array are usually: driving prefabricated pipe piles, installing posts, installing clamps, diagonal beams and diagonal braces, leveling the bracket, welding the posts, installing purlins, installing diagonal beam tie rods, installing other systems components. Before the initial installation, it is necessary to take an installation image for each installation step in the photovoltaic array installation process, and load the installation procedure into the robot.

In one embodiment, the step of pre-shooting an image of installation components for each installation step during the photovoltaic system installation process, specifically comprises:
Classifying the installation components according to functional categories, and obtaining the overall installation sequence of the installation components of each functional category and the corresponding images of the installation components;
Obtaining the individual installation sequence and the corresponding individual installation image of each installation component.

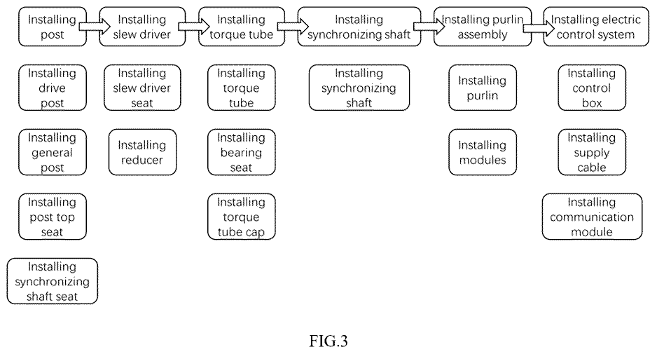

Referring to FIG. 3 of the specification, when a photovoltaic system such as a tracking photovoltaic system is installed, each major installation step can be subdivided into several sub-steps. In specific operations, the various installation components of the photovoltaic system can be classified according to functional categories. First, the overall installation sequence of the installation components of each functional category and the corresponding installation component images are obtained, and then the individual installation sequence of each installation component and the corresponding individual installation image are obtained, so as to obtain a complete installation procedure.

The disassembly procedure is reversely deduced from the pre-input installation procedure, specifically comprises:
The disassembly procedure is obtained by reversing the installation sequence of the installation components in the installation procedure one by one and the individual installation sequences of the installation components one by one.
After obtaining the installation procedure for each installation component of the photovoltaic system, the disassembly procedure of the installation components of the photovoltaic system can be obtained by reversing the installation sequence of the installation components in the installation procedure and the individual installation sequence of each installation component one by one.
Taking a conventional photovoltaic system such as a fixed bracket as an example, according to the installation steps in FIG. 2, the corresponding disassembly steps are: a first step of disassembling the photovoltaic modules, a second step of disassembling the diagonal beam rods, a third step of disassembling the purlins, a fourth step of disassembling the brackets on the welded posts, a fifth step of disassembling the clamps, diagonal beams, and diagonal braces, and a sixth step of confirming that the array is disassembled except for the posts.
Taking the tracking photovoltaic system as an example, when the installation steps are subdivided according to functional categories, there are individual installation components of different functional categories, and correspondingly, there are also different individual installation sequences. Take the use of robots to install and disassemble the posts of a tracking photovoltaic system as an example: A first step is to install a drive post on a pre-placed foundation pile in the power station. This step is a welding process. The disassembly robot imports the image of the drive post for visually distinguishing the type of the drive post during subsequent disassembly. A second step is to install a general post on the pre-placed foundation pile in the power station. This step is also a welding process. The disassembly robot imports the picture of the general post for visually distinguishing the type of the general post during subsequent disassembly. A third step is to install a slew driver seat on the drive post, using bolts, nuts, etc. with specification of M 16 and a torque value of 160-210 Nm. The image and torque value of the slew driver seat are correspondingly imported into the disassembly robot for subsequent visual distinction of the type of installation components, and the corresponding torque value is used to remove the mounting bolts of the slew driver seat. A fourth step is to install a top seat on the general post, using bolts, nuts, etc. with specification of M12 and a torque value of 70-85 Nm. The image and torque value of the post top seat are correspondingly imported into the disassembly robot for subsequent visual distinction of the type of installation components, and the corresponding torque value is used to disassemble the mounting bolts of the top seat. The post installation process is loaded into the disassembly robot, and the disassembly robot can use reversed steps to disassemble the post. Specifically: a first step is to visually confirm the type of the post seat and move the robot to the front of the post seat. A second step is that the robot arm uses a torque value of 70-85 Nm to disassemble the M12 bolts on the post top seat. A third step is to visually confirm the type of the slew driver seat and move the robot to the front of the slew driver seat. A fourth step is that the robot arm uses a torque value of 160-210 Nm to disassemble the M16 bolts on the slew driver seat. A fifth step is to visually confirm that only types of general posts and drive posts are left in the array, and the disassembly task is completed.

In one embodiment, after establishing remote interaction between the control center and at least one robot, the process specifically comprises:
Controlling the robot to grab a substitutive component corresponding to the installation component to be replaced in the target photovoltaic system, and go to the location of the target photovoltaic system;
Controlling the robot to disassemble the installation component to be replaced in the target photovoltaic system according to the disassembly procedure, and to install the substitutive component according to the installation procedure;
Controlling the robot to grab the disassembled installation component and go to a preset placement location for placing disassembled installation component.

Specifically, when replacing a photovoltaic system, it includes the disassembly of an old system (i.e., the target photovoltaic system) and the installation of a new system (i.e., the substitutive photovoltaic system), as well as the transportation of the disassembled installation components and the substitutive components. In this solution, the robot can be controlled to go to the location of the substitutive components and grab them, then go to the location of the target photovoltaic system, put down the substitutive components, disassemble the installation components to be replaced and install the substitutive components, and finally the robot is controlled to grab the substitutive components and place them at the preset placement location.

In other embodiments, the old system may be disassembled first, and the robot may be directly controlled to go to the target photovoltaic system location to disassemble the installation components to be replaced, and then the robot may be controlled to grab the disassembled installation components to the location of the substitutive components, and then put down the disassembled installation components, grab the substitutive components and return to install the substitutive components.

In some embodiments, there are two robots. The control center controls the two robots to move synchronously, and disassemble the target photovoltaic system and install the substitutive photovoltaic system respectively from two sides.

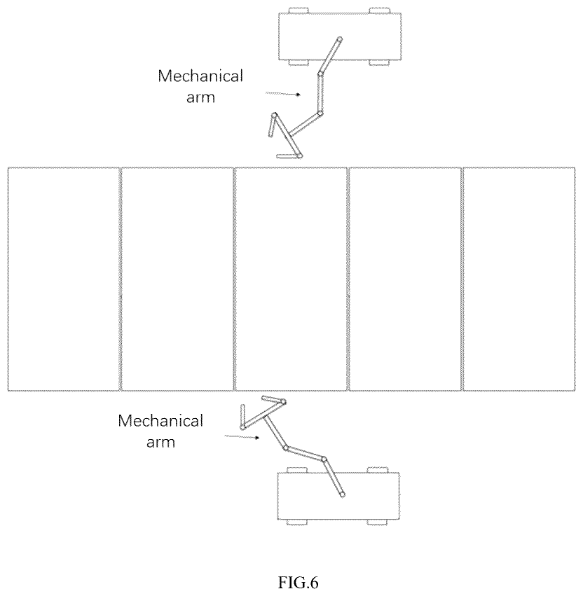

Referring to FIG. 6 of the specification, in this embodiment, the number of robots is two, and the control center controls the two robots to move synchronously to jointly perform the disassembly and substitutive operations of the system. Specifically, when disassembling the damaged installation components, the two mobile robots autonomously reach two sides of the planned target photovoltaic system by remote control or navigation, and use an onboard visual camera or cameras to identify the system, and disassemble the target photovoltaic system respectively from two sides. When carrying the substitutive components to be installed, the two mobile robots reach the location of the photovoltaic system by remote control or navigation, and use the onboard visual camera or cameras to find the borders on both sides of the photovoltaic system, and obtain the specific coordinate position through visual positioning, laser radar, etc. The mechanical arms drive the mechanical manipulators to extend to the borders and grasp them, and the two mobile robots keep operating synchronously, and then carry the substitutive components to be installed to the target installation positions by remote control or navigation. When installing the substitutive components to be installed, after the two mobile robots reach the bracket position, the target installation position is obtained through the visual camera or cameras, and then the laser radar and ultrasonic sensor assist the mobile devices to make the two mobile robots reach the two sides of the installation position respectively, and the mechanical arms lift the substitutive component to be installed, and the substitutive component to be installed is placed on an upper part of the bracket, and then the substitutive component to be installed is installed.

In one embodiment, the present invention further provides a photovoltaic system substitutive system, including a control center and at least one robot, wherein the robot establishes remote interaction with the control center.

The control center controls the robot to go to the location of the target photovoltaic system. The robot disassembles the target photovoltaic system according to a preset disassembly procedure, and install the substitutive installation components according to a preset installation procedure. The disassembly procedure is reversely deduced from the preloaded installation procedure.

Referring to FIG. 4 and FIG. 5 of the specification, the back-end control center can remotely interact with the robot via 4G, 5G or other signal transmission methods. While completing remote control, it can also monitor the on-site situation in the back-end control center through a visual camera. The functions of the back-end control center mainly include task management module, real-time monitoring module, user configuration module, system debugging and maintenance module, etc. Among them, the task management module mainly realizes the functions of comprehensive inspection, routine inspection, customized tasks, map selection and task display of the photovoltaic site. The real-time monitoring module mainly realizes the functions of video monitoring, work report viewing and robot control. The user configuration module mainly realizes the functions of alarm threshold configuration, alarm message subscription configuration, authority management, typical work point location configuration, and work area configuration. The system debugging and maintenance module mainly realizes the functions of preset tracking navigation planning route, map maintenance, software configuration and robot configuration.

While replacing the installation components of the photovoltaic system, the installation procedure of the photovoltaic system is first loaded, and the disassembly procedure is reversely deduced based on the installation procedure. When replacing the installation components, the robot disassembles the target photovoltaic system according to the derived disassembly procedure, and then install the substitutive installation components according to the preset installation procedure, thereby achieving the replacement of the system. Each type of photovoltaic system corresponds to an installation procedure. Before replacing, it is necessary to first identify the type of the system to be replaced, and then load or select the corresponding installation procedure.

This solution uses a control center to remotely control robots to disassemble and install photovoltaic systems, which can achieve automatic replacement of photovoltaic systems and reduce manual operations, which is conducive to improving efficiency and reducing the risk of labor injury. It is suitable for photovoltaic system replacement in remote regions.

In one embodiment, referring to FIG. 6 of the accompanying drawings of the specification, there are two robots, and each robot comprises a mobile chassis and a mechanical arm rotatably connected to the mobile chassis movable at 360 degrees, and each mechanical arm is movably connected with a mechanical manipulator.

The control center controls the two robots to move synchronously, and controls the robotic arms and mechanical manipulators to disassemble the target photovoltaic system and install the substitutive photovoltaic system from both sides.

Referring to FIG. 6 of the specification, in this embodiment, the number of robots is two, and the control center controls the two robots to move synchronously to jointly perform the disassembly and substitutive operations of the system. Specifically, when disassembling the damaged installation components, the two mobile robots autonomously reach the two sides of the planned target photovoltaic system by remote control or navigation, and use the onboard visual camera to identify the system, and disassemble the target photovoltaic system from both sides. When installing the substitutive components, the two mobile robots reach the location of the photovoltaic system by remote control or navigation, use the onboard visual camera to find the borders on both sides of the photovoltaic system, and obtain the specific coordinate position through visual positioning, laser radar, etc. The mechanical arm drives the mechanical manipulator to extend to the border and grasp it, and the two mobile robots keep operating synchronously, and then carry the substitutive component to be installed to the target installation position by remote control or navigation. When installing the substitutive components to be installed, after the two mobile robots reach the bracket position, the target installation position is obtained through the visual camera, and then the laser radar and ultrasonic sensor assist the mobile devices to make the two mobile robots reach the two sides of the installation position respectively, and the mechanical arms lifts the substitutive components to be installed, and the substitutive components to be installed are placed on the upper part of the bracket, and then the substitutive components to be installed are installed.

In one embodiment, the photovoltaic system substitutive system further comprises a camera module. The camera module is installed on a mechanical arm or on a mechanical manipulator, and is used to obtain images of the photovoltaic system in real time. In this embodiment, the camera module can be a visual camera, etc. In other embodiments, other camera devices can also be selected according to actual conditions and needs.

In one embodiment, the mobile chassis further comprises a communication module and a positioning module.

The communication module is used to exchange information with the control center and receive control instructions from the control center.

The positioning module is used to obtain the current position of the robot, as well as the current position of the target photovoltaic system and the substitutive photovoltaic system. In this embodiment, the positioning module can be a laser radar, an ultrasonic radar, etc. In other embodiments, other positioning devices can also be selected according to actual conditions and needs.

It should be noted that the above embodiments can be freely combined as needed. The above is only preferred embodiments of the present invention. It should be pointed out that for ordinary technicians in this technical field, several improvements and modifications can be made without departing from the principle of the present invention, and these improvements and modifications should also be considered within the protection scope of the present invention.

1. A photovoltaic system substitutive method, characterized by including steps:
establishing remote interaction between a control center and at least one robot;
controlling the robot or robots to go to a location of a target photovoltaic system via the control center;
disassembling the target photovoltaic system according to a preset disassembly procedure by the robot or robots, and installing a substitutive photovoltaic system according to a preset installation procedure, wherein the disassembly procedure is reversely deduced from the installation procedure preloaded.

2. The photovoltaic system substitutive method according to claim 1, characterized in that before said disassembling the target photovoltaic system according to a preset disassembly procedure by the robot or robots, the method further includes:
pre-shooting an image of installation components for each installation step during an installation process of a photovoltaic system, and obtaining an installation sequence of the installation components;
obtaining installation parameters of the installation components;
obtaining an installation procedure of the photovoltaic system and loading the installation procedure into the robot or robots, according to the images of installation components and the installation sequence of the installation components, combining the installation parameters of the installation components.

3. The photovoltaic system substitutive method according to claim 2, characterized in that said pre-shooting an image of installation components for each installation step during an installation process of a photovoltaic system, specifically includes:
classifying the installation components according to functional categories, and obtaining an overall installation sequence of the installation components of each functional category and corresponding images of installation components;
obtaining an individual installation sequence and a corresponding individual installation image of each installation component.

4. The photovoltaic system substitutive method according to claim 3, characterized in that said the disassembly procedure is reversely deduced from the installation procedure preloaded, specifically comprising:
obtaining the disassembly procedure by reversing the installation sequence of the installation components in the installation procedure, and the individual installation sequence of each installation component one by one.

5. The photovoltaic system substitutive method according to claim 2, characterized in that after establishing remote interaction between the control center and at least one robot, the method further comprises:
controlling the robot or robots to grab a substitutive component corresponding to an installation component to be replaced in the target photovoltaic system, and go to the location of the target photovoltaic system;
controlling the robot or robots to disassemble the installation component to be replaced in the target photovoltaic system according to the disassembly procedure, and install the substitutive component according to the installation procedure;
controlling the robot or robots to grab a disassembled installation component and go to a preset placement location for placement.

6. The photovoltaic system substitutive method according to claim 5, characterized in that two robots are provided; and
the control center controls the two robots to move synchronously, and to disassemble the target photovoltaic system and install the substitutive photovoltaic system respectively from two sides.

7. A photovoltaic system substitutive system, characterized by comprising:
a control center; and
at least one robot, which establishes remote interaction with the control center;
wherein the control center controls the robot or robots to go to a location of a target photovoltaic system; and
the at least one robot disassembles the target photovoltaic system according to a preset disassembly procedure, and installs a substitutive photovoltaic system according to a preset installation procedure, wherein the disassembly procedure is reversely deduced from the preloaded installation procedure.

8. The photovoltaic system substitutive system according to claim 7, characterized in that two robots are provided, and each of the robots comprises a mobile chassis and a mechanical arm 360°-rotatably connected to the mobile chassis, and the mechanical arm is movably connected with a mechanical manipulator; and
the control center controls the two robots to move synchronously, and controls the mechanical arms and the mechanical manipulators to disassemble the target photovoltaic system and install the substitutive photovoltaic system respectively from two sides.

9. The photovoltaic system substitutive system according to claim 8, characterized by further comprising:
a camera module, installed on the mechanical arm or the mechanical manipulator and used to obtain photovoltaic system images in real time.

10. The photovoltaic system substitutive system according to claim 8, characterized in that the mobile chassis comprises:
a communication module, used to exchange information with the control center and receive control instructions from the control center; and
a positioning module, used to obtain a current position of one of the two robots, and to obtain current positions of the target photovoltaic system and the substitutive photovoltaic system.

11. The photovoltaic system substitutive method according to claim 2, characterized in that the installation parameters comprise a torque value of one of the installation components.

12. The photovoltaic system substitutive method according to claim 11, characterized in that when installing the substitutive photovoltaic system according to the preset installation procedure, the torque value is used to disassemble the corresponding installation component to be replaced.

13. The photovoltaic system substitutive method according to claim 11, characterized in that the image is used for subsequent visual distinction of type of structural components.

14. The photovoltaic system substitutive method according to claim 12, characterized in that the torque value is a torque value of a mounting bolt or a nut.

15. The photovoltaic system substitutive method according to claim 1, characterized in that each type of photovoltaic system corresponds to an installation procedure, and before replacing, the type of the photovoltaic system to be replaced is identified, and a corresponding installation procedure is loaded or selected.

16. The photovoltaic system substitutive method according to claim 6, characterized in that each of the robots comprises a mobile chassis and a mechanical arm 360°-rotatably connected to the mobile chassis, and the mechanical arm is movably connected with a mechanical manipulator; and
the control center controls the mechanical arms and the mechanical manipulators to disassemble the target photovoltaic system and install the substitutive photovoltaic system respectively from two sides.

17. The photovoltaic system substitutive method according to claim 16, characterized in that:
a camera module is installed on a mechanical arm or a mechanical manipulator and is used to obtain photovoltaic system images in real time.

18. The photovoltaic system substitutive method according to claim 16, characterized in that the mobile chassis comprises:
a communication module, used to exchange information with the control center and receive control instructions from the control center; and
a positioning module, used to obtain a current position of one of the two robots, and to obtain current positions of the target photovoltaic system and the substitutive photovoltaic system.

19. The photovoltaic system substitutive method according to claim 17, characterized in that:
the camera module is a visual camera used to identify the photovoltaic system.

20. The photovoltaic system substitutive method according to claim 19, characterized in that:
the visual camera is used to find borders on two sides of the photovoltaic system, for the mechanical arms to drive the mechanical manipulators to extend to the borders and grasp the borders.
